(19) United States
(12) Patent Application Publication
(10) Pub. No.: US 2016/0029603 A1
(43) Pub. Date: Feb. 4, 2016

(54) BEEHIVE AND BEEHIVE SYSTEM

(71) Applicant: Andreas HEIDINGER, Dachau (DE)

(72) Inventor: Andreas HEIDINGER, Dachau (DE)

(21) Appl. No.: 14/781,900

(22) PCT Filed: Apr. 3, 2014
(86) PCT No.: PCT/EP2014/056717

§ 371 Date: Oct. 1, 2015

(30) Foreign Application Priority Data
Apr. 3, 2013 (DE) 10 2013 005 587.3

(51) Int. Cl. A01K 47/02; A01K 47/06

(52) U.S. Cl. CPC A01K 47/02; A01K 47/06

(57) ABSTRACT

The present invention relates to a beehive (1,1a,1b) having a container (3) for receiving or containing honeycomb frames (6) and a cover (2) for removing the honeycomb frames (6), wherein the container (3) and the cover (2) form with their inner surface (45, 46) an inner area which has in a vertical middle section of said inner area a maximum horizontal diameter, and said horizontal diameter decreases, at least locally, towards the vertical ends of the inner area, characterized in that the container (3) comprises at least one container section, which forms, with its inner surface (46) towards the inner area, a concave surface within said container section. Furthermore the present invention encompasses a beehive system (30).

The present invention relates to a beehive and a beehive system.

Beehives with an inner space comprising at least one edge are known in the state of the art. In particular, mobile embodiments with polyhedral forms having detachable honeycomb bars have prevailed.

As the isolation of these wooden, box-shaped beehives is often not ideal, also styrofoam hives having improved thermal transmittance are available.

Furthermore, there is the hanging basket. The latter has a straw-plaited egg design. Due to complexity and high manufacturing costs, the hanging basket could not win recognition by beekeepers.

In addition, beehives, where a space expansion for the bee colony is achieved by adding an angular form made of wood or Styrofoam, are also known in the state of the art. The bee colony needs the expansion of space for enlarging the brood chamber and for storing honey (honey chamber). A disadvantage of this expansion is that bees need to heat more and bee brood may possibly be, therefore, not thoroughly supplied with heat anymore (in particular at 35° Celsius). This may lead to diseases and brood loss.

An object of the present invention is to propose a beehive that provides optimized climate conditions in the inner space.

The object of the present invention is achieved by a beehive with the features of claim 1.

A beehive is suggested having multiple-part housing. In the beehive, at least two honeycomb frames are arranged. The housing comprises at least one damage-free removable housing part or section, which is designed as a cover, for removing the honeycomb frames. The inner space of the housing defined by a container and the cover has a maximum horizontal diameter in a vertical central space of the housing. At least one horizontal diameter decreases towards both vertical ends of the housing, respectively. It is preferred that the diameter decreases in both directions over a large vertical trail. In this way, for example an egg-shaped, spherical or cone-shaped inner space is formed. The container comprises at least one container section, which forms, with its inner surface towards the inner space, a concave surface of the container section.

The central space extends from 10 percent of the vertical extension to 90 percent of the vertical extension, preferably from 20 percent to 80 percent of the vertical extension, in particular from 30 percent to 70 percent of the vertical extension and particularly advantageous is from 40 percent to 60 percent of the vertical extension.

The concave surface may thereby be approached. Also inner surfaces whose enveloping surface is somehow concave shall be included, such that the inner space of the beehive is spherical or egg-shaped, in a mounted position with respect to the enveloping surfaces.

A production deviating from the classical plaiting is considered possible by the described construction.

The construction according to the present invention makes it possible to create an energy-efficient housing of bees. The air tightness increases and the relation of space to surface is improved, particularly by a substantially spherical interior.

The high energy efficiency, particularly through the less heat flow to the outside, makes handling of the beehive less work-intensive, as the brood chamber does not necessitate increasing or decreasing anymore.

With this construction according to the preset invention, the beehive is not subject to temperature variations, due to weather conditions influenced by time of day or season of the year, anymore. Consequently, the bee colony spends or dedicates less energy for regulating heat in the beehive. The consumption of food in the cold seasons of the year decreases.

The construction according to the present invention avoids thermal bridges, such that the risk of mold growth is low.

As a result, the bee colonies in such beehives are more vital and more stable or resistant against diseases.

In an advantageous embodiment of the present invention, the container comprises at least two container sections having a concave surface at their inner surface towards the interior, respectively. The container sections are interconnected in a tight or bonded or form-fit manner.

Selecting a multiple-piece designed container, enables an efficient and therefor cost-effective handling via modern machining centers.

Small sealing gabs are preferably achieved by the best possible sealing of the passages between the sections. The flow of heat to the outside may be reduced. Furthermore, the sealing of the beehive is made easier for the bees as they require, if any, less propolis. Pathogens and parasites may thus be prevented from penetrating into the beehive.

In a further advantageous embodiment of the beehive, the interior is substantially spherical or ovoid.

These geometries are adapted to the natural construction of bee colonies in an ideal manner, providing as such a good ratio between surface and room. It is important that no thermal bridges are created, which preferably happens at 90 degree angles. It is also conceivable that the round form of the interior is approached by a multiple-angle form and therefore achieving similar effects.

In a further advantageous embodiment of the beehive, the container sections are diffusion-open or diffusion permeable. Such construction enables humidity to exit to the outside through the walls of the beehive, hence, preventing mold growth and ensuring an optimal interior climate. Due to the predominant air tightness of the construction, it is essential to select the right material.

The beehive is preferably made of wood. By selecting the corresponding thickness of the material, a properly isolated beehive is obtained which is most adapted to the natural home of the bees, e.g. in a hollow trunk of a tree.

In a further embodiment according to the present invention, the honeycomb frames are peripherally closed.

The weight of the honeycomb frames may lead to tearing off the latter by an open construction. Such exceptional situation shall also be considered in the commercial use of the beehive.

In a further advantageous embodiment according to the present invention, the honeycomb frames are arranged in a vertical section plane through the interior on the form of the inner surface of the beehive.

The interior is used by such configuration optimally.

In a further advantageous embodiment according to the present invention, there is a bee way or path between the honeycomb frames and the inner surface of the beehive.

Short bee ways and maximum freedom of movement is important for the bees. Traditionally, a sheet or cloth is placed particularly in the space of the cover of the beehive, hence, the freedom of movement for the bees is hindered. Condensed water may gather or form below the sheet which may lead to mold growth.

In a further preferred embodiment, the bee way between particularly the inner surface of the cover and the honeycomb frames has a height between 3 and 15 mm or preferably between 5 and 10 mm (defined space).

With respect to the present invention, bees wax honeycombs constructed by the bee colony in the space between the cover and the honeycomb frames is remedied. Surprisingly, bees avoid, advantageously, constructing a bee way with the selected range or measurements. When removing the cover, the gluing from the inner surface of the cover and the honeycomb frames may, in the prior art, lead to damaging the honeycomb frames. Consequently, the honeycomb frames or also the honeycomb bars do not need to be covered with a sheet or cloth which is known from the prior art as a remedy.

In a further advantageous embodiment of the present invention, the honeycomb frames are fixed to the container by means of a fixing unit. In particular, the fixing is arranged to be detachable. The honeycomb frames may preferably be manually fixed by the fixing means to the container and detached from it manually.

In an advantageous embodiment of the invention, the fixing unit is designed with honeycomb frame hold-down pins. After inserting the honeycomb frames, the hold-down pins may be shifted or pushed, such that the honeycomb frames are fixed in the desired position.

The fixing unit makes it advantageously possible to prevent that the honeycomb frames are undesirably lifted up when opening the cover, due to the gluing of the honeycomb frames with the cover by beeswax.

In a further advantageous embodiment of the present invention, the honeycomb frames are inserted in the grooves provided on the section of the container. These positioning devices designed as grooves may ensure the optimal space between the honeycomb frames, when manipulating in an easy manner.

In a preferred embodiment of the present invention, the entrances are arranged in a space below the middle space.

In a further embodiment of the present invention, the beehive comprises a closing slider for closing the entrance at least partially. The entrances for bees to enter into the beehive may be, e.g. depending on the season of the year or implementation situation, temporarily closed. The size of the totally opened entrance (i.e. size of the opened space or hole for bees to enter into the beehive) may vary. The closing slider may be referred to as entrance slider.

The closing slider may alternatively be used for closing the connecting holes which are not used.

In a further embodiment of the present invention, there is an air circulation chamber between, on the one side, the inner surface of the container and/or the cover and, on the other side, the honeycomb frames. The air circulation of the inner surface may prevent mold growth. The circulation may be ensured by the construction, such that e.g. spherically arranged honeycomb frames have a suitable or enough space to the inner surface of the housing part, i.e. the cover and container. Necessary gabs based on the mounting of the honeycomb frames are kept small.

The object according to the present invention is achieved by a beehive system having the features of claim 14. The beehive system comprises two beehives for expanding the space needed, wherein the two beehives are interconnected. In particular, the two beehives are connected in a detachable manner, e.g. via adapter.

The first and the second beehive of the beehive system may be identical or different. They are advantageously horizontally adjacent to each other.

In an advantageous embodiment of the present invention, the beehives of the beehive system are interconnected via connection holes which may be arranged on the side of the beehives. For example, a closing slider may close the connection holes. The connection holes of the beehives of the beehive system may be interconnected via the adapter.

In a further embodiment, the connection holes are those used as entrances, for bees to enter into the beehive, when they are not in use as connection holes.

Separating the expansion of space, e.g. via the closing slider, enables wintering the bee colony advantageously. The bee colony needs more space after having bred in spring. Such additional room may be provided with this expansion of space according to the present invention by using a similar or identical second room.

After collecting or harvesting the honey, the second room or chamber (and/or further rooms) may be uncoupled and the bee colony may for example be wintered again in one room.

The construction according to the present invention allows for an energy-efficient beehive and an optimal storage of honey. With this construction according to the present invention, the chambers are not subject to extreme temperature variations influenced by day/night time or season of the year. Consequently, the bee colony spends less energy for regulating heat in the beehive.

The honey quality may advantageously improve as it is easier to extract water from honey due to higher thermal level.

The weight load for the beekeeper when collecting the honey is reduced.

Through the high energy efficiency of the beehive according to the present invention, the construction of honeycombs is rendered easy for the bees. It is easier to remove the honeycombs filled with honey.

The honeycombs may be pressed after having been removed or may be completely consumed as a high-quality honey combs. Honey spinning can be avoided.

In a further embodiment of the present invention, the beehive comprises a first ventilation system which consists of one or more sliders and guiding bars. The slider and the guiding bars are arranged particularly at the lower side of the beehive. The slider and the guiding bars may be combined together with the so-called varroa grid holder and the tray (or the tray diagnosis board). A ventilation system may be adjusted, depending on the requirement, by adjusting the varrao grid holder, the tray or the tray diagnosis board, the slider (the slider may also be referred to as space slider) and the guiding bars. This first ventilation system may include a system function.

In a further embodiment of the present invention, the first ventilation system is combined with an analysis system. The combined system includes a varroa grid holder, a tray diagnosis board, a space slider and guiding bars. The system functions like a 3-panel or stock drawer; it allows the space slider to be pulled initially which, thus, causes the varroa grid holder and the tray diagnosis board to drop downwardly. This is advantageous because a squeezing or crushing of bees can be prevented. Subsequently, the varroa grid holder together with the tray diagnosis board are pulled out for waste diagnosis. Dead bees for example may lie on the varroa grid holder. There may be waste (e.g. wax remains or varroa mites) lying on the tray diagnosis board.

The ventilation system may be referred to as a system for air regulation. The ventilation system may additionally or alternatively be designed for air and moisture compensation.

Air and/or humidity in the beehive may be regulated by means of the first ventilation system.

In a further embodiment of the present invention, the beehive has a second ventilation system which consists of a ventilation divider, shavings chamber and a ventilation slider. Implementing the second ventilation system may occur depending on the season of the year and/or implementation situation. Air and/or humidity may be regulated by means of the second ventilation system.

The ventilation slider may be used particularly as a slider for the entrance.

In a further embodiment of the present invention, the first and second ventilation system are combined. For example, by a prevailing high humidity, the use of both ventilation systems may rapidly reduce humidity.

In a further embodiment of the present invention, the beehive comprises at least one separating panel for reducing space. Said separating panels may be provided in different sizes. Thereby, the bees may be selectively provided with required space, hence, improving the energy efficiency of the beehive.

In a further embodiment of the present invention, the beehive comprises a form-fit in a separating plane between the cover and the container. The form-fit may straighten uneven surfaces in the separating plane.

The form-fit may furthermore include a step in the separating plane. The step may alternatively or additionally (to the form-fit) balance uneven surfaces in the separating plane.

The form-fit and/or the step have an advantageous effect on the bees through high heat efficiency and less propolis consumption. Furthermore, an eventual warping in a wooden construction is straightened for the bees by means of the form-fit and/or the step. A warping of wood may be, at least to a certain dimension of the warping due to partially permanent and/or elastic deformation, be fitted together by means of the form-fit and/or the step.

In a further embodiment of the present invention, the beehive comprises a guiding groove as a guiding rail or bar for the closing slider (which is exemplarily used as an entrance slider). The entrance may advantageously be regulated by the entrance slider. The ventilation slider and/or the closing slider may advantageously be used depending on the season of the year or reasons for use.

Hereinafter, the present invention shall be described with reference to the appended figures. In the figures, identical reference numerals denote similar or identical elements.

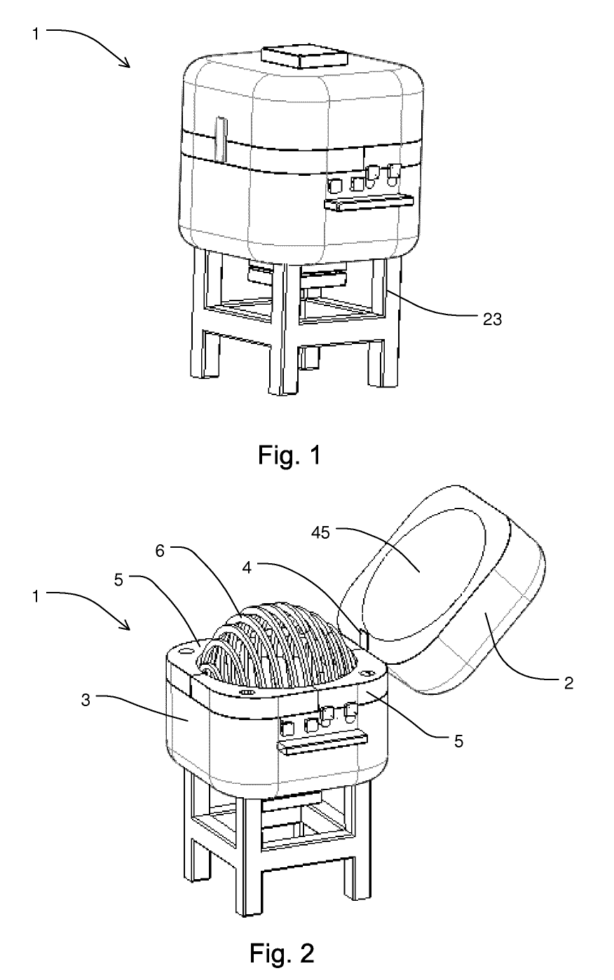

FIG. 1 shows a perspective outer view of the beehive according to the present invention;

FIG. 2 shows a perspective view of the beehive according to the present invention with an open cover;

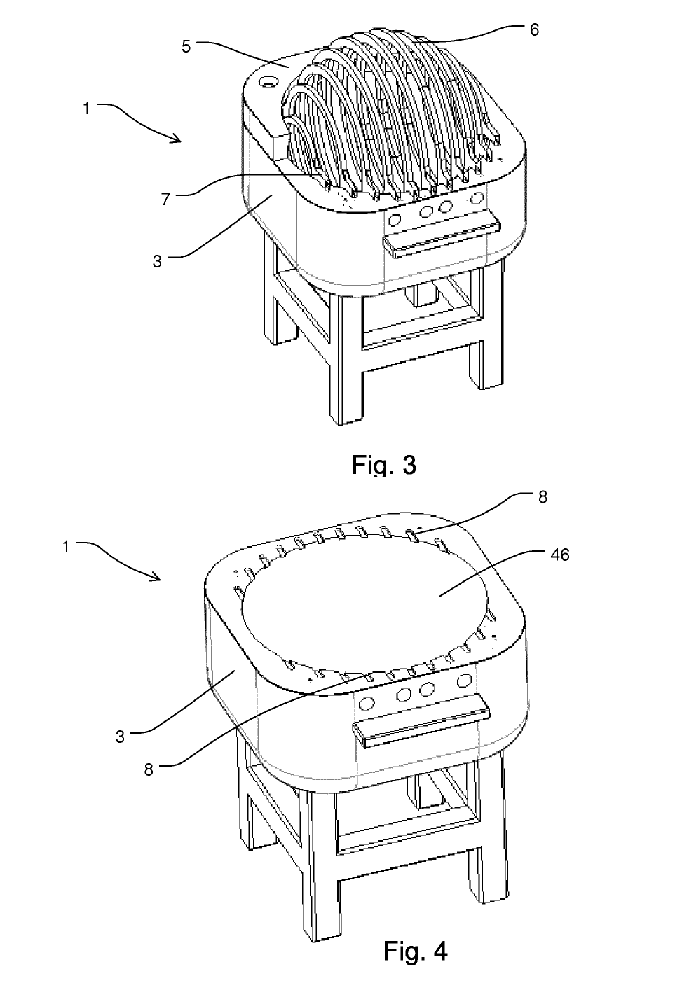

FIG. 3 shows a perspective view of the beehive according to the present invention without cover, with inserted or mounted honeycomb frames and one of four central flanges;

FIG. 4 shows a perspective view of the lower or bottom half of the beehive without cover and without round honeycombs;

FIG. 5 shows the honeycombs in a non-mounted state;

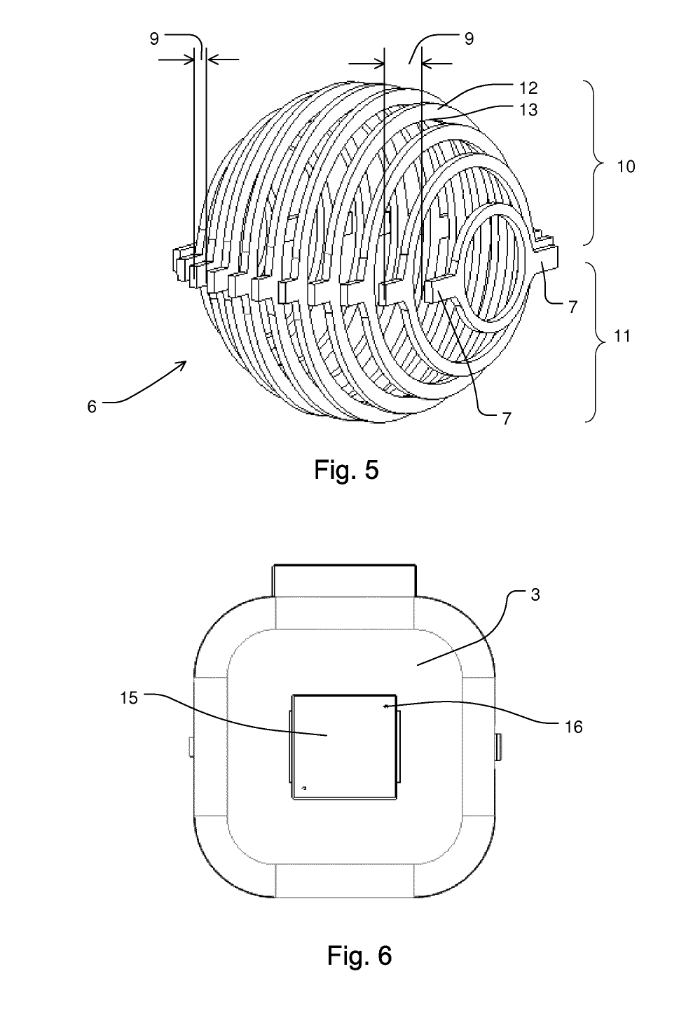

FIG. 6 shows a view from below of the beehive according to the present invention;

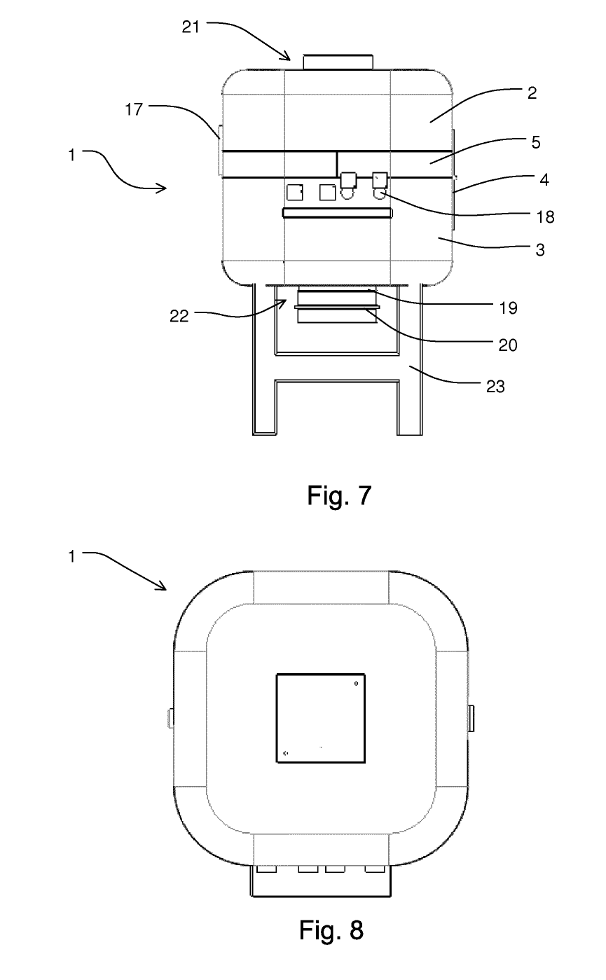

FIG. 7 shows a front view of the beehive according to the present invention;

FIG. 8 shows a top view of the beehive according to the present invention;

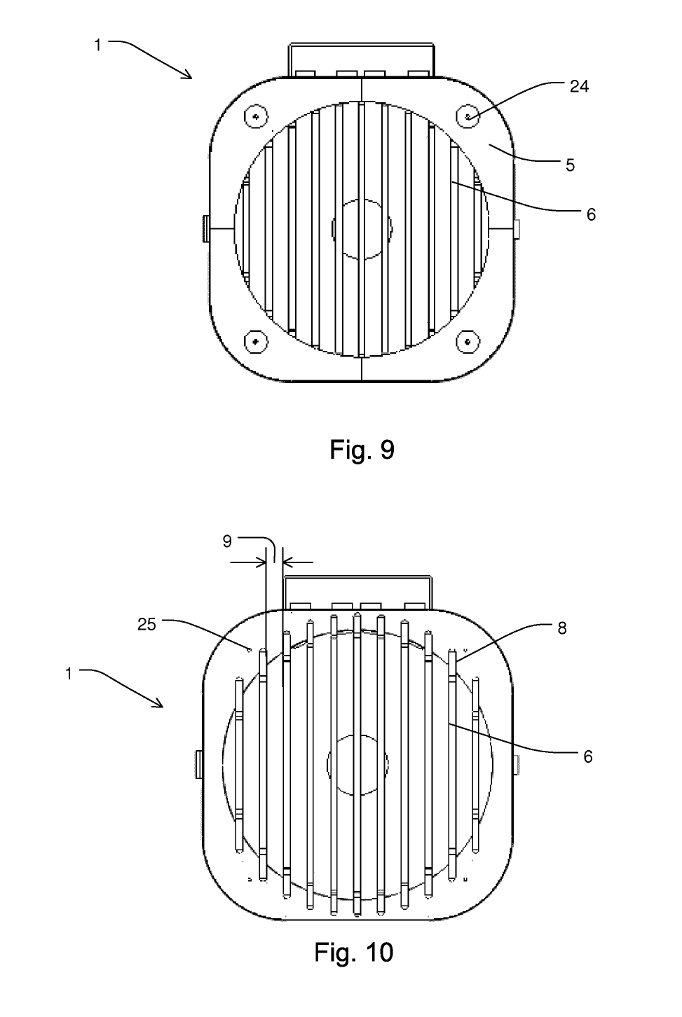

FIG. 9 shows a top view of the beehive with a removed cover;

FIG. 10 shows a top view of the honeycombs positioned in the grooves;

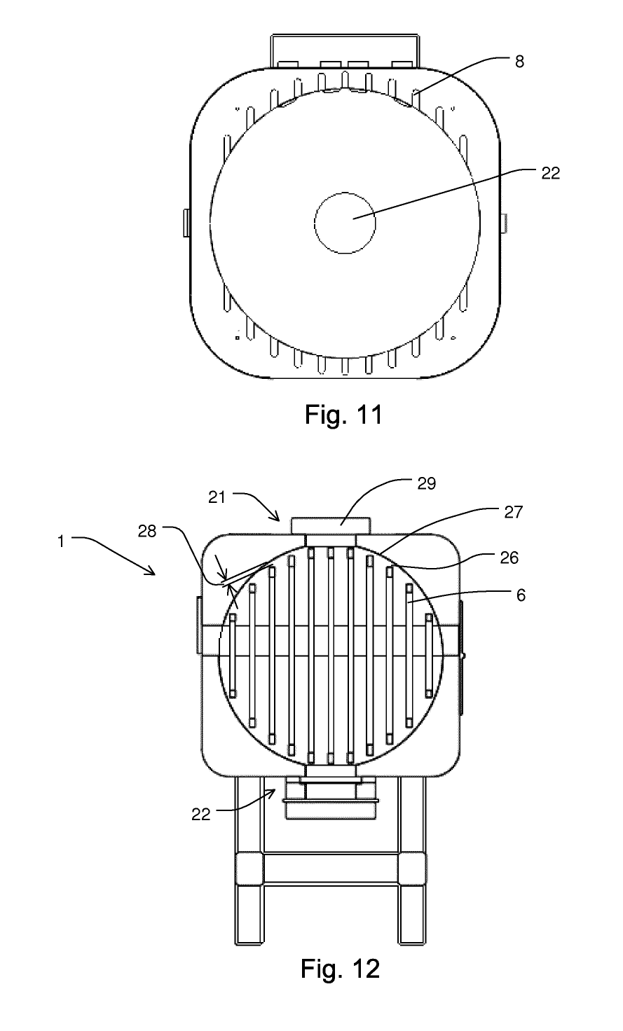

FIG. 11 shows a top view of the container with non-mounted honeycomb frames;

FIG. 12 shows a vertical cross section of the beehive according to the present invention;

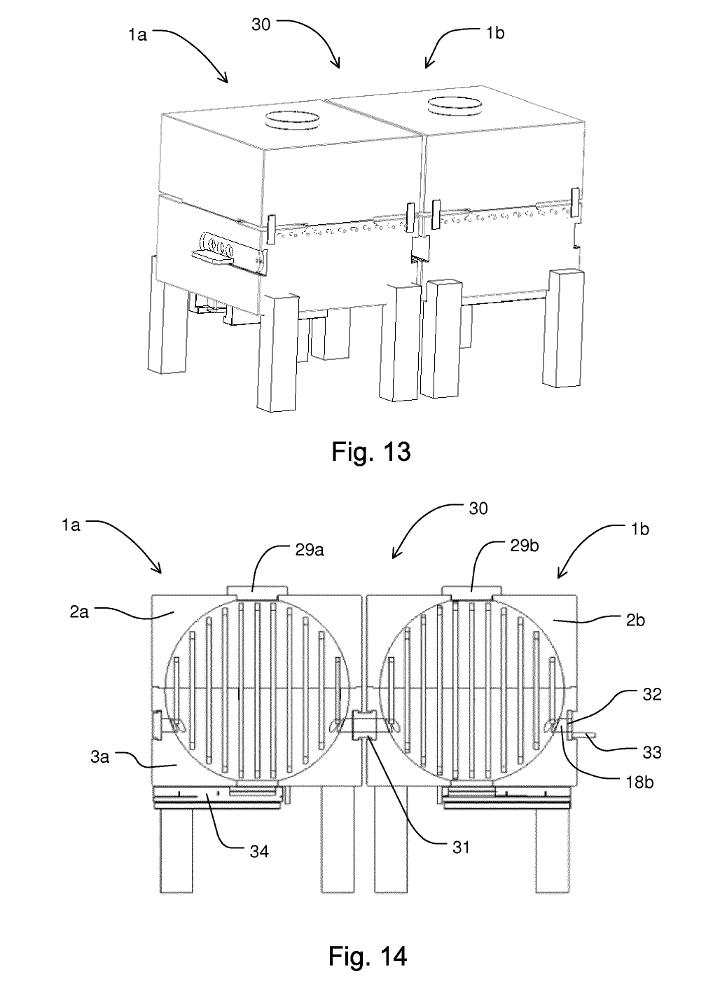

FIG. 13 shows a perspective front view of two interconnected beehives according to the present invention;

FIG. 14 shows a longitudinal cross section of the two interconnected beehives according to the present invention;

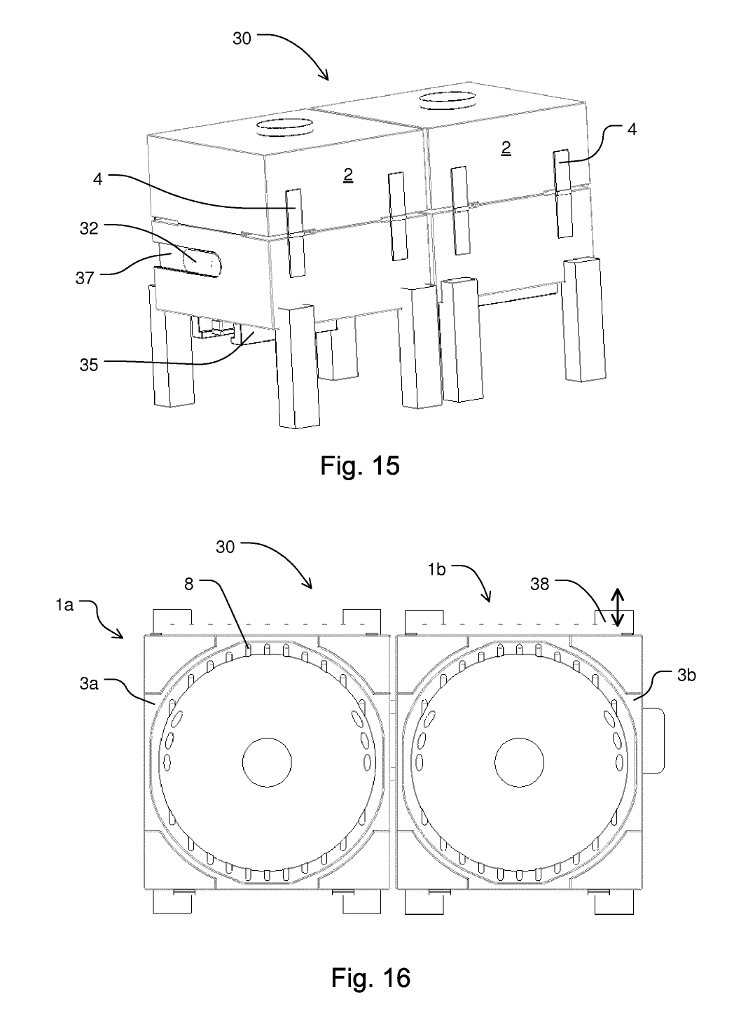

FIG. 15 shows a perspective rear view of the two interconnected beehives according to the present invention;

FIG. 16 shows a top view of the containers of the two interconnected beehives;

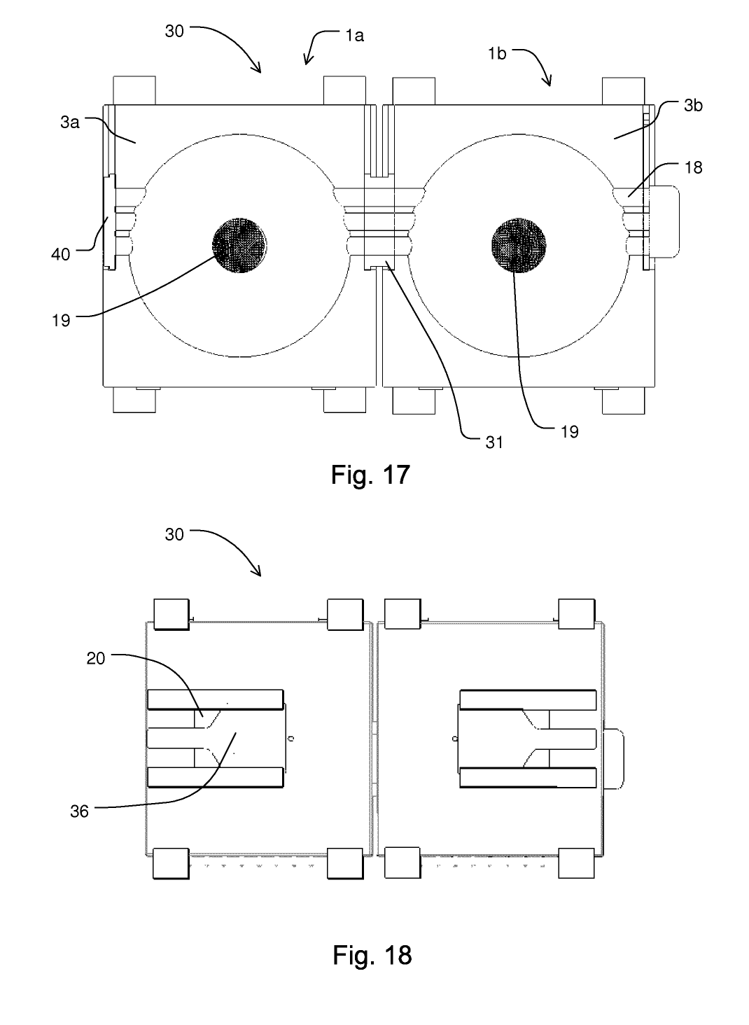

FIG. 17 shows a horizontal section (central to the entrances)

FIG. 18 shows a view from below of the two connected beehives according to the present invention;

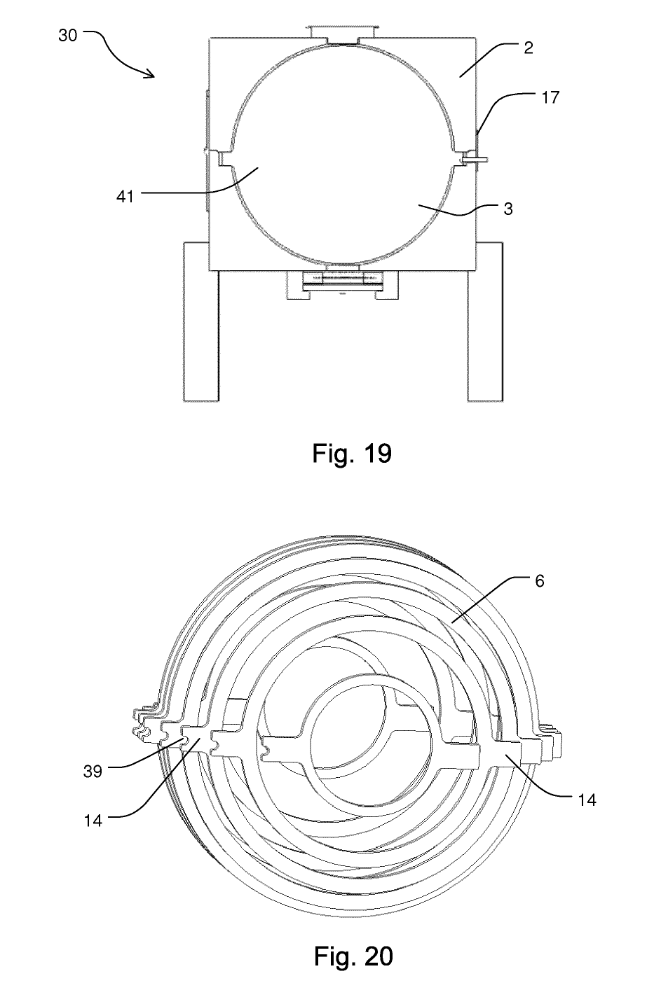

FIG. 19 shows a longitudinal section with a separating panel of the beehive according to the present invention;

FIG. 20 show the honeycomb frames in a non-mounted state;

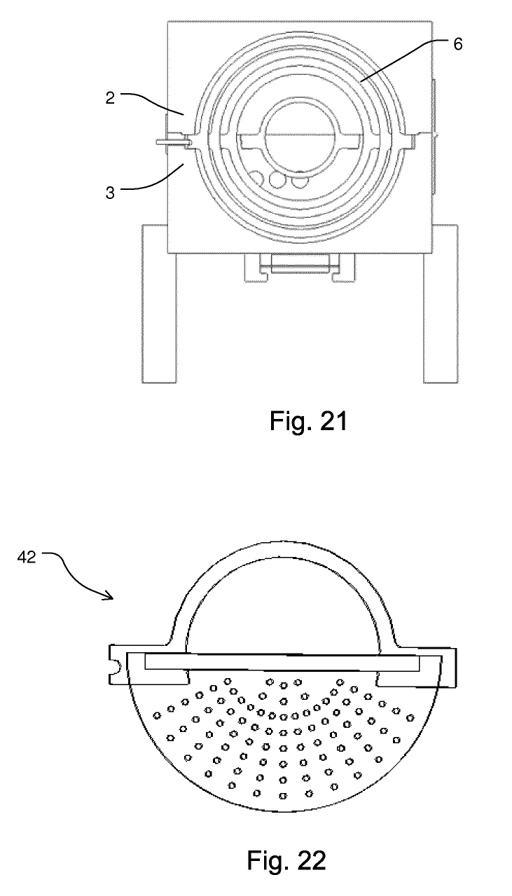

FIG. 21 shows a vertical section of the beehive according to the present invention;

FIG. 22 shows a ventilation divider

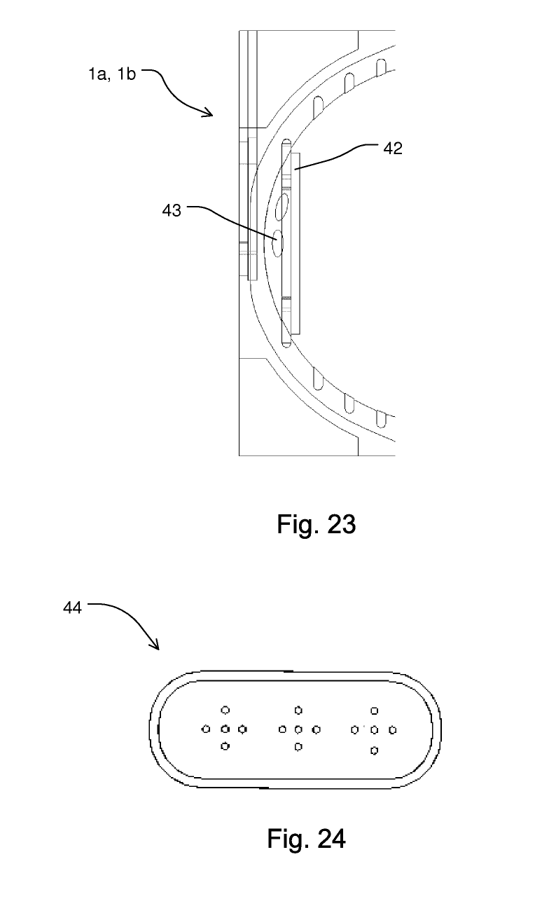

FIG. 23 shows the ventilation divider in mounted state in the beehive according to the present invention;

FIG. 24 shows a ventilation slider.

FIG. 1 shows a perspective exterior view of the complete, closed beehive 1 according to the present invention, on a frame 23.

The beehive 1 may be referred to as spherical hive 1.

FIG. 2 shows a perspective view of the beehive 1 according to the present invention with an open cover 2. The beehive 1 is open in this view. The cover 2 is provided for closing the container 3 or the inner chamber between cover 2 and container 3. The cover 2 is opened up by means of a fitting (synonymous to: hinge, box binding).

The cover 2 comprises an inner surface 45.

Flanges 5 are arranged, in this embodiment, on the container 3 for fixing the honeycomb frames. In FIG. 2, four segmented flanges 5 are arranged, meaning that the flange is quartered. Alternatively, only two instead of four (flange divided in two halves) or one flange 5 may be arranged to fix the honeycomb frames to the container 3. The flanges 5 are screwed tight or fixed to the container 3 with at least one bolt per flange segment. The honeycomb frames 6 may be prevented from rising by means of the flange 5. Said rising may occur due to local beeswax between the cover 2 and the honeycomb frames 6.

FIG. 3 shows a flange segment of a four-piece flange 5 covering the bearing pin 7 of honeycomb frames 6. The bearing pins 7 may be referred to as honeycomb frame bearing 7 The single honeycomb frames 6 may be removed out of the container 3 after the flanges 5 or the single flange segments have been detached.

FIG. 4 shows a perspective view of the bottom half of the beehive 1, of the container 3, without cover 2 and without honeycombs 6. The honeycombs 6 are inserted into grooves 8 for the honeycomb frame 6.

The container 3 comprises an inner surface 46.

FIG. 5 shows the honeycomb frames 6 in a non-mounted state. The honeycomb frame 6 comprise, depending on the planned mounting position, different diameters. FIG. 5 shows how the different diameters of the honeycomb frames 6, in a center-to-center-distance 9 of the honeycomb frames to each other, form a ball shape (ball-shaped arranged honeycomb frames 6). The center distance 9 of the honeycomb frames 6 to each other is preferably approx. 35 mm.

The defined space of the upper half 10 of the honeycomb frames 6 to the cover 2 (not shown in FIG. 5) is important, as beeswax may occur between the upper honeycomb frame 10 and the cover 2 with a space differing from the given specified. Having a small space, bees may not be able to move through the honeycomb frames 6 and the cover 2. The bottom half 11 of the honeycomb frames 6 serve to support the filled honeycombs and to stabilize the closed honeycomb frames 6.

If a new bee swarm is brought into the beehive 1, the bees start constructing the honeycomb at the inner side 13 of the honeycomb bar 12 in the upper half 10 of the honeycomb frames 10. There is no need to mount beeswax starting strips.

The honeycomb bearings 7 (or bearing pins 7) are provided for bearing the honeycomb frames 6 into the grooves 8 (see FIG. 4). Therewith, a defined bearing and positioning of the honeycomb frames 6 is achieved. The defined space of the honeycomb frames 6 to the container 3 (not illustrated in FIG. 5) is important. Having a small space, bees may not be able to enter between the honeycomb frames 6 and the container 3. Furthermore, having a small space may lead to the waste (in particular varrao mites) not falling on the tray 20 (see FIG. 7, mounted tray). Keeping the beehive 1 clean is facilitated through a suitable choice of space between the honeycomb frames 6 and the container 3.

FIG. 6 shows a view from below (without base). The bottom covering or the bottom cover 15 is screwed to the container 3. The screw joints points 16 of the bottom cover are recognized.

FIG. 7 shows a front view of the beehive 1 according to the present invention.

The cover 2 is sealed with the flanges by means of a closure or lock (box closure). Thereby, the cover 2 is pressed onto the flange 5 such that the beehive 1 is tightly closed. Thus, it is rendered easy for the bees to tightly seal the beehive 1. Bees require less propolis (bee glue). Diseases and parasites may only, in a very reduced manner, penetrate into the beehive 1, as compared to a beehive 1 not being suitably sealed.

The cover 2 (the top covering of the beehive 1) is connected to the container 3 (the bottom half of the beehive 1) by means of the fitting 4. The cover 2 is thereby fixed and may be lifted up conveniently.

The entrances 18 (both entrances 18 on the right are exemplarily opened, both entrances 18 on the left are exemplarily closed with a lid or closure) may either be opened or closed depending on the bee traffic or activity and strength of the bee colony. The entrances 18 may be mice-safe adjusted. The entrances 18 may be moved to other spots of the beehive 1.

The so-called drawer system below the beehive 1 comprises, among others, a varroa grid 19, a mounted in-between rack or shelf (hereinafter denoted as tray 20) and a bottom covering 15 (the bottom covering 15 is denoted as bottom closing cover).

The varrao grid 19 is a common grid made of stainless steel or plastic.

A diagnosis of the bee colony may be executed by means of the tray 20. The latter is further used for collecting substances of the bees (in particular for waste and varroa mites)

Honey chambers and feeding chambers may be fitted to the beehive 1.

A so-called varroa treatment may be executed through the bottom opening 22 as well as through the top opening 21.

Ventilation of the beehive 1 may be regulated or adjusted through the bottom cover 15.

With respect to the design of the base 23 (the base 23 is also denoted as main body or trestle) of the beehive 1, it is important to consider having access to the tray 20 and/or to the varroa grid 19. The base 23 may be made of wood, metal tube or metal rods or may comprise said materials. It is also possible to fit the beehive 1 between branches of a tree or to hang it, thus dispensing with a base 23.

FIG. 8 shows a top view of the beehive 1 according to the present invention from above

FIG. 9 shows a top view of the beehive 1 from above without the cover 2. The flange 5 may be a four-piece design (as illustrated), wherein each single flange segment is exemplarily fixed with one or two screws 24 (e.g. hanger bolts) on the container (the bottom half of the beehive 1). The four illustrated flange segments may in particular be screwed with a wing nut at hanger bolts onto the container 3, respectively.

Bees may create a punctual beeswax honeycomb of the honeycomb frames 6 on the cover 2 (not illustrated herein). The fixing means being carried out by four segments, the flange 5, ensures that the honeycomb 6 are not pulled out of grooves 8 of the container 8 when opening the cover 2. This screw connection ensures therefore a safe lifting up of the cover 2.

FIG. 10 shows a top view of the honeycomb frames 6 positioned in the grooves 8. The honeycomb frames 6 are positioned on the container 3. The center distance is in particular approx. 35 mm. Other center distances may exemplarily be within the range of 30 mm or 40 mm.

The number of honeycomb frames 6 depends on the ball diameter (the spherical honeycomb frames 6, see description of FIG. 5) and corresponds to dividing the diameter by the center distance 9 of the honeycomb frames 6). The number of honeycomb frames 6 may vary. The hole or thread 25 shows the position of the screw connection (the screws 24) for fixing the flange parts to the container 3 of the beehive 1.

FIG. 11 shows a possible arrangement of the grooves 8, which are in particular between 1 mm and 10 mm milled in depth (in the drawing plane).

Waste of bees and varroa mites fall through the bottom opening 22. The detachable varroa grid 19 and the tray 20 (tray for catching waste) are placed or arranged below the opening 22. A varrao treatment may be performed from underneath. The concave inner form according to the present invention of the container 3 allows waste to fall through the bottom opening 22 and through the varroa grid 19 onto the tray 20, for example for performing an analysis by the beekeeper.

FIG. 12 shows a vertical cross section through the beehive 1 according to the present invention. A position for a possible, local beeswax honeycombs 26 is illustrated in FIG. 12, whereby a gluing to the inner surface 27 is likely. Wax building covering the whole surface is unlikely to take place, when the space 28 between the honeycomb frame 6 and the inner surface 27 of the cover 2 or of container 3 is suitably selected, such that bees may use this gab as a passage. However, prerequisite for this is that the defined or predetermined space 28 be complied with. In addition, a defined or predetermined space 28 between the cover 2 or the container 3 to the honeycomb frames offers an space which is very important for the interior climate in the beehive 1. There is a good air circulation in such an space. As there are substantially no corners, edges, or thermal bridges due to the round shape according to the present invention, the risk of mold growth in the beehive according to the present invention is low.

The top opening 21 is covered with a removable cover 29. Said top opening 21 has a plurality of functions. A new bee swarm may be implemented by this top opening 21 into an empty beehive. A funnel may be disposed on or pushed into the top opening 21. Thus, bees may be moved into the beehive 1. The top opening 21 allows for controlling the bee colony. A honey chamber may, depending on design and size of honeycomb frames, be arranged. Likewise, a feeding chamber may, when necessary, be arranged for feeding the bees.

Waste of bees and varroa mites fall through the bottom opening 22. A detachable varroa grid 19 and a tray 20 (tray for catching waste) are placed below the opening 22. A varrao treatment may be performed from below. The concave inner form of the container 3 allows waste to fall through the bottom opening 22 and through the varroa grid 19 onto the tray 20, for example for performing an analysis by the beekeeper. The beehive 1 may thus be maintained clean for the bees much easier. In order to guarantee a proper slipping of waste into the waste opening, the opening 22 is selected to be large enough, such that the slopes formed through the inner surface of the container 3 are sufficiently steep. The spherical shape (concave inner surface of the container 3 and the cover 2) infront of the waste opening may also optionally be locally adjusted or varied to achieve a larger slope.

FIG. 13 shows a perspective front view with two adjacent beehives 1a, 1b according to the present invention being connected to each other.

The two beehives 1a, 1b may be considered as a complete, closed two-chamber hive 30. The two-chamber hive 30 includes a plurality of functions and tasks for the bee keeper. The first beehive 1a and the second beehive 1b of the two-chamber beehive 30, illustrated exemplarily, are designed identically. However, the tasks and functions of both beehives 1a, 1b are different. The first inner chamber of the first beehive 1a serves in first place as a brood chamber and wintering chamber. In case the bee colony requires more space, the second inner chamber of the second beehive 1b may be hooked up or attached by means of an adapter 31 (see FIG. 14). This second inner chamber may be used as both honey chamber or an extended brood chamber. With that, the optimal space or space for the bee colony may be provided by the bee keeper. The second chamber may be used for bee colony increase (formation of new colonies). Further beehives 1 may be attached.

FIG. 14 shows a longitudinal cross section of the hooked up two-chamber beehive 30.

The cover 2a (the cover 2a may be denoted as top container 2a) The top covering 20a shows the closing cover of the first beehive 1a. The entrances 18b of the second beehive 1b may be closed by means of an entrance slider 32 or the size of their entrances may be regulated. A platform 33 serves for alighting and landing of bees. The platform 33 is fixed to the entrance 32.

A holder 34 for the varroa grid 19 (not shown in FIG. 14) is represented at the bottom side of the beehive 1a. The container 3a shows the bottom side of the beehive 1a.

FIG. 15 shows a perspective back view of the hooked up two-chamber beehive 30 according to the present invention.

The fittings 4 (hinges) are provided for opening and closing the cover 2a, 2b.

Varroa grid holder 34, the tray 20 (not illustrated in FIG. 15) and a space slide 36 (see FIG. 18) are held or guided in the guiding bars 35.

The entrance slider 32, a closing slide 40 (see FIG. 17) for closing the side opening and/or a coupling piece (for joining the two beehives 1a, 1b with the two-chamber beehive 30) are inserted in a guiding groove 37.

FIG. 16 shows a top view of the containers 3a, 3b, of the two-chamber beehive 30.

The grooves 8 are provided and designed for receiving the honeycomb frame bearing 7 (see FIG. 5).

In the embodiment of the two-chamber beehive 30, the fixing of the honeycomb frames 6 or the honeycomb frame bearing 7 is not carried out by means of flanges 5, as performed in FIGS. 1 to 12, rather by means of an alternative fixing form via comb frames hold-down pins 38, as performed hereinafter. Basically however, both fixing variations are alternatively applicable.

The honeycomb frames hold-down pins 38 are used for holding down the comb frames 6, which are guided or inserted in the grooves 8, when opening the beehive 1a, 1b.

The honeycomb frames hold-down pins 38 seal the honeycomb frames 6 through the notch 39 shown in FIG. 20 (the notch 29 may be denoted as groove). By means of this, it should be ensured in case of eventual construction of surplus wax at the honeycomb frames 6, that opening the beehive 1a, 1b is possible without concurrently removing the honeycomb frames 6. After opening the beehive 1a, 1b, the comb frames hold-down pins 38 are withdrawn until the comb frames are unlocked. At this point, the honeycomb frames 6 are removed out of the respective container 3a, 3b.

In the embodiments shown in FIG. 16, the comb frames hold-down pins 38 are arranged to the side at four edges. Said arrangement may basically be carried out at other points of the beehive 6.

FIG. 17 shows a horizontal section (central to the entrance hole) of the containers 3a, 3b (bottom half of the two-chamber beehive 30).

The varrao grids 19 are arranged centrally. The adapter 31 (see FIG. 14) hooks up the two beehives 1a, 1b (to be more exact: the two inner chamber of the beehives 1a, 1b) to form a two-chamber beehive 30.

The closing slide 40 closes the side opening.

FIG. 18 shows a view from below of the two-chamber beehive 30 according to the present invention.

The tray 20 (analysis tray) is removed for analyzing waste (waste of bees, varroa mites, wax particles etc.). For this, the waste falls through the varroa grid 19 onto the tray 20. To carry out the waste control, the space slider is removed initially. Thereby, it is ensured that no bees are crushed while removing the varrao grid holder. The ventilation of the two-chamber beehive 30 (or the respective beehives 1a, 1b) may also be regulated with the space slider 36 (which is led into the guiding bar 35) and the tray 20.

FIG. 19 shows a longitudinal section of the two-chamber beehive 30 with a mounted divider 41.

The inner chamber for the bee colony is varied and regulated by means of the divider 41 for reaching optimal spaces for the bee colony. The divider 41 serves for the optimal energy efficiency, such that an unnecessary heating of the chambers for the bees is avoided.

The cover 2 is pressed onto the container 3 with the adjustable box closure 17 such that the beehive 1a, 1b is tightly sealed. With that, it is easier for the bees to seal the dividing surface between cover 2 and the container 3. Therefore, bees require less propolis. Hence, pathogens and parasites may penetrate less into the beehive 1a, 1b.

FIG. 20 shows the honeycomb frames 6 in a non-mounted state. The number of honeycomb frames 6 may vary. The notch 39 (recesses at the comb frame bearing 14) serve for the hold-down of the honeycomb frame 6 while opening the beehive 1a, 1b. The comb frame bearing 7 are placed in the grooves 8 in the container 3.

FIG. 21 shows a vertical section of the beehive 1a, 1b according to the present invention with mounted honeycomb frames 6. The form fit is illustrated in the dividing plane between the cover 2 and the container 3. The dividing surface in the illustrated form fit is arranged as a shifted step. The work effort for sealing the division with propolis is reduced for the bees with the form fit and/or the step. The surfaces of the edges are lowered or set down in FIG. 16. Therefore, the risk of crushing bees by closing the beehive 1a, 1b is minimized.

FIG. 22 shows a ventilation divider 42. The ventilation divider is applicable for ventilation (carbon dioxide (CO₂) compensation in the beehive) and/or by higher humidity.

FIG. 23 shows the ventilation divider 42 in a mounted state in the beehive 1a, 1b according to the present invention. The wooden shavings 43 absorb the moisture in case of high humidity in the beehive. The risk of mold forming is therefore reduced. Since the wooden shavings mixture is permeable to air, a ventilation by the ventilation divider 44 is therefore possible.

FIG. 24 shows a ventilation divider 44. The ventilation divider 44 may be used as a locking slider 40 (see FIG. 17). The locking slider 40 closes in particular the entrance hole 18.

### LIST OF REFERENCE NUMERALS

1,1a,1b beehive, spherical hive
2,2a,2b cover
3 container
4 fitting, hinge, box binding
5 flange
6 honeycomb frame
7 bearing pin
8 groove (for the honeycomb frame)
9 center distance (of the honeycomb frames to each other)
10 upper half of the honeycomb frame
11 lower half of the honeycomb frame
12 honeycomb bar
13 inner side of the honeycomb bar
15 bottom cover of the container; bottom covering
16 screw joint points
17 closure or lock; box closure or lock
18 entrance
19 varrao grid or fence
20 tray; mounted tray in-between
21 upper opening
22 lower opening
23 base; main base; trestle
24 screws
25 hole; thread
26 position of a possible, local beeswax honeycombs
27 inner surface of the cover
28 distance between honeycomb and inner surface
29,29a,29b top cover of the beehive
30 two-chamber beehive
31 adapter
32 entrance slider
33 platform
34 holder for varrao grid; varrao grid holder
35 guiding bar
36 space slider
37 guiding groove
38 honeycomb frame-hold-down pins
39 notch
40 lock slider
41 Separating panel for closing partially or completely
42 ventilation divider
43 chamber of wooden shavings
44 ventilation slider
45 inner surface of the cover
46 inner surface of the container

1. A beehive (1,1a,1b) having a container (3) for receiving honeycomb frames (6) and a cover (2) for removing the honeycomb frames (6), wherein the container (3) and the cover (2) form with their inner surfaces (45, 46) an inner space which has in a vertical middle section a maximum horizontal diameter which decreases at least locally towards the vertical ends of the inner space, characterized in that the container (3) comprises at least one container section which forms with its inner surface, which faces the inner space, a concave surface of the container section.

2. The beehive (1,1a,1b) according to claim 1, characterized in that the container (3) comprises at least two container sections, which form, respectively, with their inner surfaces, which face the inner space, a concave surface of the container section, wherein said container sections are connected cohesively or form-fitted.

3. The beehive (1,1a,1b) according to claim 1, characterized in that a bee way is formed between the honeycomb frames (6) and the inner surface (45, 46) of the beehive (1,1a,1b).

4. The beehive (1,1a,1b) according to claim 3, characterized in that the bee way between the inner surface (45) of the cover (2) and the honeycomb frames (6) has a height between 3 mm and 15 mm, in particular between 5 mm and 10 mm.

5. The beehive (1,1a,1b) according to claim 1, characterized in that the honeycomb frames (6) are fixed to or at the container (3) by means of a fixing unit.

6. The beehive (1,1a,1b) according to claim 5, characterized in that the honeycomb frames (6) are manually fixed to or at the container (3) with the fixing unit in a detachable manner.

7. The beehive (1,1a,1b) according to claim 1, characterized in that the honeycomb frames (6) are arranged in grooves (8) provided on the container section.

8. The beehive (1,1a,1b) according to claim 1, characterized in that the beehive (1, 1a,1b) comprises a first ventilation system which comprises in particular a space slider (36) and guiding bars (35).

9. The beehive (1,1a,1b) according to claim 1, characterized in that the beehive (1, 1a,1b) comprises a second ventilation system which comprises in particular a ventilation divider (42), a shavings chamber (43) and a ventilation slider (44).

10. The beehive (1,1a,1b) according to claim 1, characterized in that the beehive (1,1a,1b) comprises an entrance slider (32) for at least partially closing the entrance.

11. The beehive (1,1a,1b) according to claim 1, characterized in that the beehive (1,1a,1b) comprises a separating panel (41) for reducing space.

12. The beehive (1,1a,1b) according to claim 1, characterized in that the beehive (1,1a,1b) has a form fit in a dividing plane between the cover (2) and the container (3).

13. The beehive (1,1a,1b) according to claim 1, characterized in that the beehive (1,1a,1b) comprises a guiding groove (37) as guiding rail for an adapter (31) and/or as guiding rail for the ventilation slider (32) and/or as guiding rail for the entrance slider (32).

14. A beehive system (30), characterized in that at least two beehives (1,1a,1b) are interconnected, for increasing space.

15. A beehive system (30) according to claim 14, wherein each of the at least two beehives (1,1a,1b) is a beehive according to claim 1.

16. A beehive system (30) according to claim 14, wherein the at least two beehives are interconnected by an adapter.

17. The beehive (1,1a,1b) according to claim 2, characterized in that a bee way is formed between the honeycomb frames (6) and the inner surface (45, 46) of the beehive (1,1a,1b).
